(19) United States
(12) Patent Application Publication
(10) Pub. No.: US 2010/0014478 A1
(43) Pub. Date: Jan. 21, 2010

(54) Radio Communication Terminal Device, Radio Communication Base Station Device, and Radio Resource Allocation Method

(75) Inventors: Sadaki Futagi, Ishikawa (JP); Daichi Imamura, Kanagawa (JP); Atsushi Matsumoto, Ishikawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, OASKA (JP)

(21) Appl. No.: 12/528,609

(22) PCT Filed: Feb. 25, 2008
(86) PCT No.: PCT/JP2008/000325

§ 371 Date: Aug. 25, 2009

(30) Foreign Application Priority Data
Feb. 26, 2007 (JP) 2007-045979
Jun. 19, 2007 (JP) 2007-161933

(51) Int. Cl. H04W 72/04

(52) U.S. Cl. 370/329

(57) ABSTRACT

Disclosed are a radio communication terminal device, a radio communication base station device, and a radio resource allocation method which can reduce radio resource fragmentation while suppressing increase of the signaling quantity in data retransmission. In ST201, a base station (150) groups a plurality of users. In ST203, the initial transmission resource allocated to a plurality of users in the group and having a higher frequency is decided to be the retransmission radio resource to be shared by the plurality of users in the group. In ST207, a mobile station (100) transmits data to the base station (150). In ST208, the base station (150) generates for a plurality of users in the group, ACK/NACK information which can be mutually decoded by the users. In ST209, the ACK/NACK information is transmitted to the mobile station (100). In ST210, according to the ACK/NACK information, the mobile station (100) allocates the retransmission radio resource. In ST211, the mobile station (100) retransmits data by using the retransmission radio resource.

### TECHNICAL FIELD

The present invention relates to a radio communication terminal apparatus, a radio base station apparatus and radio resource allocation method using synchronous HARQ.

### BACKGROUND ART

Presently, in data transmission in 3GPP RAN LTE (Long Term Evolution), studies are conducted to adopt HARQ, which improves data throughput by combining new received data and data received earlier, Synchronous HARQ or asynchronous HARQ is studied to be adopted as HARQ.

Synchronous-HARQ has features of having smaller signaling overhead and having simpler circuit configuration than asynchronous HARQ, and therefore use of synchronous-HARQ in uplink has been agreed upon. Here, “synchronous” refers to the time interval between the time or the previous time data is transmitted, and the time data is retransmitted is determined in advance as a fixed time interval.

Further, in synchronous-HARQ, non-adaptive HARQ whereby the modulation scheme, the coding rate and the transmission band upon a data retransmission are determined in advance, adaptive HARQ whereby the modulation scheme, the coding rate and the transmission band upon a data retransmission can be changed, are studied to implement (e.g. see Non-patent Document 1).

Here, FIG. 1 shows the case of using radio resources in synchronous/non-adaptive HARQ, and FIG. 2 shows the case of using radio resources in synchronous/adaptive HARQ. In the case of using non-adaptive HARQ, retransmission is controlled by an ACK or NACK, by retransmitting data using the MCS (Modulation and Coding Scheme) allocated upon the initial transmission and a resource block (RB) upon receiving a NACK, it is possible to suppress an increase in the amount of signaling involved in the retransmission. On the other hand, in the case of using adaptive HARQ, by changing the MCS and RB in addition to the ACK or NACK, it is possible to perform retransmit adequately for radio states and improve data throughput.

Non-patent Document 1: 3 GPP TSG-RAN WG1 Meeting Ad Hoc LTE, R1-060231, Huawei “Considerations on Synchronous HARQ in Uplink”, Helsinki, Finland, 23-25 Jan., 2006

### DISCLOSURE OF INVENTION

### Problems to be Solved by the Invention

However, in the above-described non-adaptive HARQ retransmission technique, vacant fields of radio resources fragment upon a data retransmission and a plurality of users need to use resources especially in uplink, and therefore signaling for allocating resources to a plurality of users increases. This reason will be explained below.

In non-adaptive HARQ, it is possible that any user data is retransmitted, depending on error conditions, it is possible that vacant resources are fragmented as shown in FIG. 1. Especially, in uplink, when a plurality of fragmented RBs are allocated to the same user, PAPR (Peak to Average Power Ratio) deteriorates, and it is necessary to secure greater back off margin than in normal cases. By this means, a plurality of fragmented RBs cannot be allocated to the same user, and it is possible to allocate a plurality of fragmented RBs to a plurality of different users. For this reason, the amount of signaling for allocating the resources to a plurality of users increases.

By contrast with this, while the retransmission technique of adaptive HARQ makes it possible to change radio resources for retransmission for incorrect users, and therefore vacant resources do not fragment, the amount of signaling nevertheless increases by reporting changes of radio resources for retransmission often.

It is therefore an object of the present invention to provide a radio communication terminal apparatus, radio communication base station apparatus and radio resource allocation method that reduce fragmentation of radio resources while suppressing an increase in the amount of signaling upon data retransmissions.

### Means for Solving the Problem

The radio communication terminal apparatus of the present invention adopts the configuration including: a receiving section that receives acknowledgment and negative acknowledgment information for the radio communication terminal apparatus and other radio communication terminal apparatuses placed in a group, the acknowledgment and negative acknowledgment information being decodable by all radio communication terminal apparatuses in the group; a retransmission control section that makes consecutive radio resources on a higher frequency end or on a lower frequency end in radio resources allocated to the group radio resources for retransmissions for shared use in the group, and allocates the radio resources for retransmission based on the acknowledgment and negative acknowledgment information; and a transmission section that transmits retransmission data using the allocated radio resources for retransmission.

The radio communication base station apparatus of the present invention adopts the configuration including: a group determination section that determines a plurality of radio communication terminal apparatuses placed in a group and determines order of priority in the plurality of radio communication terminal apparatuses; and a transmitting section that transmits acknowledgment and negative acknowledgment signals of quality according to the priority for radio communication terminal apparatuses placed in a group, the acknowledgment and negative acknowledgment signals being decodable by all radio communication terminal apparatuses in the group.

The radio resource allocation method of the present invention includes: a receiving step of receiving acknowledgment and negative acknowledgment information for the radio communication terminal apparatus and other radio communication terminal apparatuses placed in a group, the acknowledgment and negative acknowledgment information being decodable by all radio communication terminal apparatuses in the group; and a retransmission control step of making consecutive radio resources on a higher frequency end or on a lower frequency end in radio resources allocated to the group radio resources for retransmissions for shared use in the group, and allocating the radio resources for retransmission based on the acknowledgment and negative acknowledgment information.

### ADVANTAGEOUS EFFECT OF THE INVENTION

According to the present invention, it is possible to reduce fragmentation of radio resources while suppressing an increase in the amount of signaling upon data retransmissions.

### BRIEF DESCRIPTION OF DRAWINGS

FIG. 1 shows the case of using radio resources in synchronous/non-adaptive HARQ;

FIG. 2 shows the case of using radio resources in synchronous/adaptive HARQ;

FIG. 3 is a block diagram showing the configuration of the mobile station according to Embodiment 1 of the present invention;

FIG. 4 is a block diagram showing the configuration of the base station according to Embodiment 1 of the present invention;

FIG. 5 is a sequence diagram showing the communication steps between the mobile station shown in FIG. 3 and the base station shown in FIG. 4;

FIG. 6 illustrates the method of allocating radio resources for retransimission upon a data retransmission, according to Embodiment 1 of the present invention;

FIG. 7 illustrates the method of allocating radio resources for retransmission upon a data retransmission, according to Embodiment 2 of the present invention;

FIG. 8 illustrates another method of allocating radio resources for retransmission upon a data retransmission, according to Embodiment 2 of the present invention;

FIG. 9 illustrates the method of allocating radio resources for retransmission upon a data retransmission, according to Embodiment 3 of the present invention;

FIG. 10 shows a flow chart showing processing in the mobile station according to Embodiment 4 of the present invention;

FIG. 11 illustrates another method of allocating radio resources for retransmission upon a data retransmission in the case where designated number of retransmissions N=1;

FIG. 12 illustrates another method of allocating radio resources for retransmission upon a data retransmission in the case to where designated number of retransmissions N=2;

FIG. 13 is a block diagram showing the configuration of the base station according to Embodiment 5 of the present invention;

FIG. 14 is a block diagram showing the configuration of the mobile station according to Embodiment 5 of the present invention;

FIG. 15 is an illustration provided to explain the user selection method in the control section shown in FIG. 14;

FIG. 16 is a block diagram showing the configuration of the base station according to Embodiment 6 of the present invention;

FIG. 17 shows signal points of 16 QAM;

FIG. 18 is a block diagram showing the configuration of the base station according to Embodiment 7 of the present invention; and

FIG. 19 is a block diagram showing the configuration of the mobile station according to Embodiment 7 of the present invention.

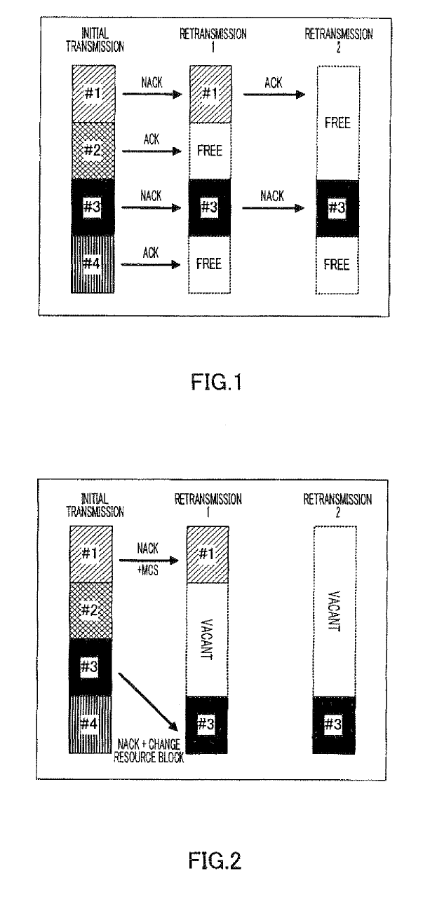

### BEST MODE FOR CARRYING OUT THE INVENTION

Now, embodiments of the present invention will be described in detail with reference to the accompanying drawings.

### Embodiment 1

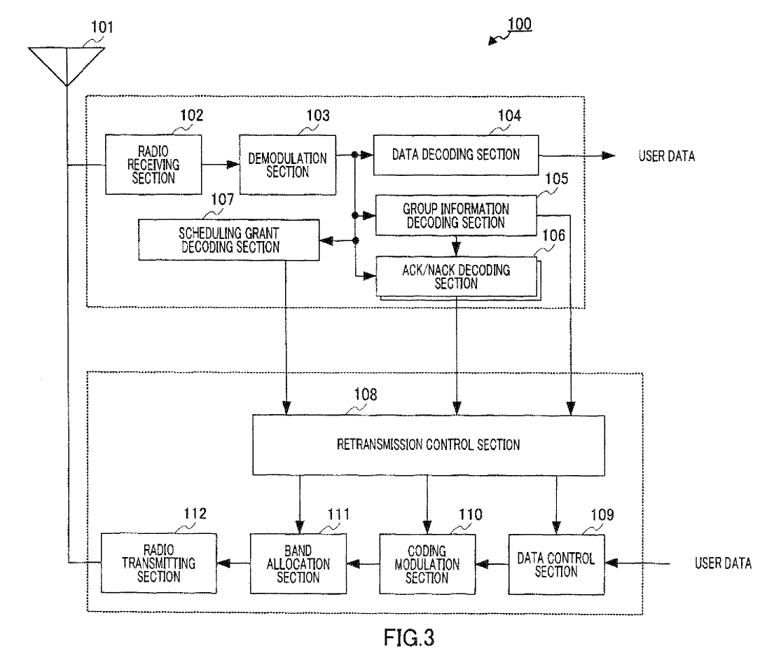

FIG. 3 is a block diagram showing the configuration of mobile station 100 according to Embodiment 1 of the present invention. Referring to this figure, radio receiving section 102 performs radio receiving process in g including frequency conversion on a received signal via antenna 101, and outputs the signal after radio receiving processing to demodulation section 103.

Demodulation section 103 estimates channel condition using the signal outputted from radio receiving section 102. Based on the estimated channel condition, demodulation section 103 performs synchronous detection processing or frequency equalization processing on the signal outputted from radio receiving section 102, and outputs the signal after synchronous detection processing or frequency equalization processing to data decoding section 104, group information decoding section 105 and ACK/NACK decoding section 106 and scheduling grant decoding section 107.

Data decoding section 104 decodes the signal outputted from demodulation section 103 according to the coding method of the transmitting side, and outputs user data.

Group information decoding section 105 decodes group information from the signal outputted from demodulation section 103. The group information refers to ACK/NACK group information showing a group, which is formed by grouping a plurality of users of the same RB size and in which all users can decode ACKs/NACKs for the users, and showing the mobile stations in the group, and control information used for decoding the order of priority between the users in the group and the ACK/NACK group information. Amongst the decoded group information, the ACK/NACK group information and its control information used to decode this information are outputted to ACK/NACK decoding section 106 and the order of priority is outputted to retransmission control section 108.

ACK/NACK decoding section 106 decodes the ACK/NACK signal outputted from demodulation section 103 using the ACK/NACK group information outputted from group information decoding section 105 and the control information used to decode the information, and outputs the decoded ACK/NACK information to retransmission control section 108. The decoded ACK/NACK information includes ACKs or NACKs for grouped users.

Scheduling grant decoding section 107 decodes MCS for data transmission, band allocation related information for the initial data transmission (RB size, RB position) and band allocation related information for data retransmissions (RB size, RB position) from the signal outputted from demodulation section 103, and outputs these decoded information to retransmission control section 108.

Using the ACK/NACK information for a plurality of users outputted from ACK/NACK decoding section 106, the MCS and band allocation information for the initial data transmission and band allocation information for data retransmissions (RB size, RB position) outputted from scheduling grant decoding section 107, retransmission control section 108 determines the number of data transmissions, MCS, redundancy version (RV) for HARQ operation determination, band allocation information for data transmission (RB size, RB position), and outputs the determined number of data transmissions to data control section 109, the MCS and RV to coding modulation section 110, and the band allocation related information to band allocation section 111.

Data control section 109 outputs user data to coding modulation section 110 according to the number of data transmissions outputted from retransmission control section 108. That is, data control section 109 outputs new user data upon the initial data transmission and outputs the same data as the initial data to coding modulation section 110 upon data retransmissions.

Coding modulation section 110 encodes and modulates the user data outputted from data control section 109 according to the MCS outputted from retransmission control section 108. Further, coding modulation section 110 performs rate matching on the data, and outputs the signal after rate matching to band allocation section 111.

Band allocation section 11I allocates the band outputted from retransmission control section 108 to the signal outputted from coding modulation section 110, and outputs the band-allocated signal to radio transmitting section 112.

Radio transmitting section 112 performs radio transmitting processing including frequency conversion on the signal outputted from band allocation section 111, and outputs the signal after radio transmitting processing from antenna 101.

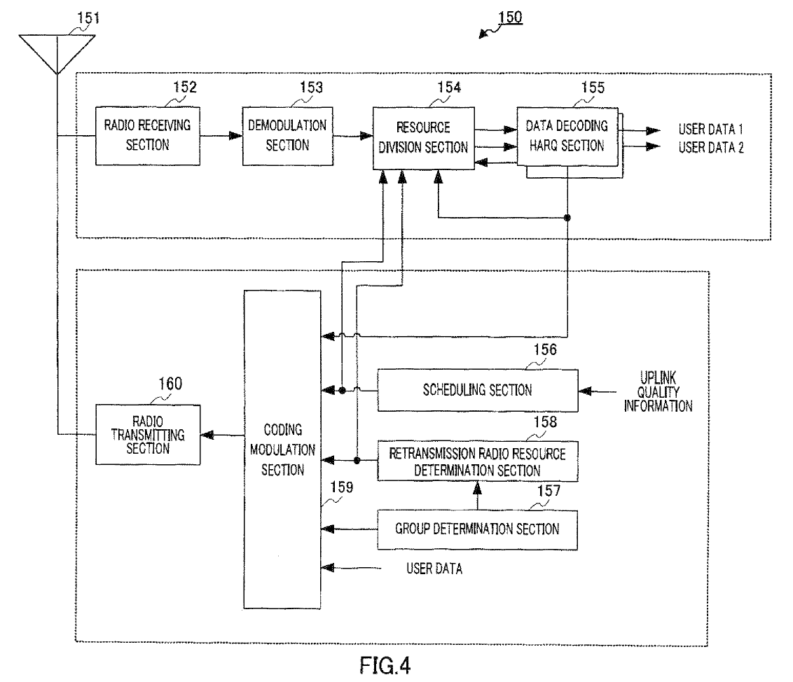

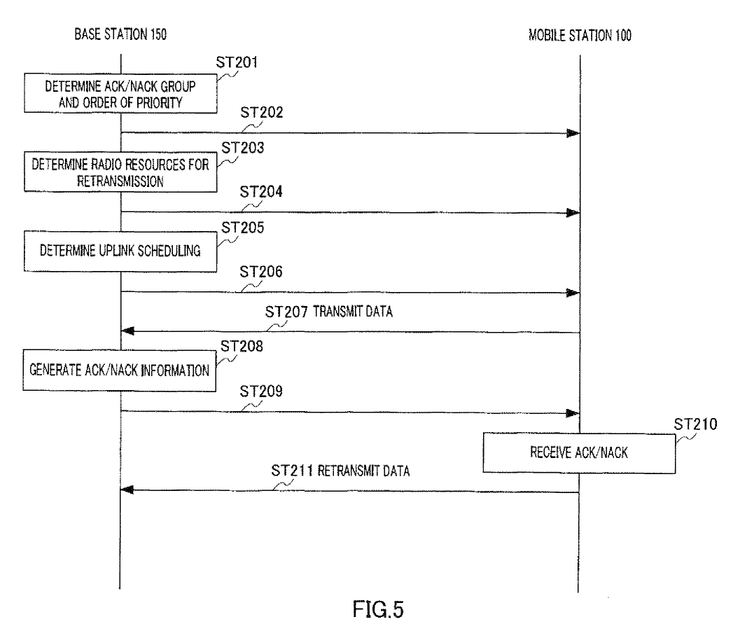

FIG. 4 is a block diagram showing the configuration of base station 150 according to Embodiment 1 of the present invention. Referring to this figure, radio receiving section 152 performs radio receiving processing including frequency conversion on a received signal via antenna 151, and outputs the signal after radio receiving processing to demodulation section 153.

Demodulation section 153 estimates channel condition using the signal outputted from radio receiving section 152. Based on the estimated channel condition, demodulation section 153 performs synchronous detection processing or frequency equalization processing on the signal outputted from radio receiving section 102, and outputs the signal after synchronous detection processing or frequency equalization processing to resource division section 154.

Using the number of retransmissions and ACK/NACK information per user outputted from data decoding HARQ section 155, band allocation information for the initial data transmission outputted from scheduling section 156, and band allocation information for data retransmissions outputted from retransmission radio resource determination section 158, resource division section 154 divides the signal outputted from demodulation section 153 into user-specific received data, and outputs the user-specific received data to data decoding HARQ section 155.

Data decoding HARQ section 155 performs decoding processing and HARQ processing on the user-specific received data outputted from resource division 154, and performs CRC decoding processing. By CRC decoding processing, data decoding HARQ section 155 outputs the ACK/NACK information to resource division section 154 and coding modulation section 159, and outputs user data if there is no error.

Scheduling section 156 specifies users that transmit uplink data and determines the MCS to designate to the specified users and band allocation information for the initial data transmission, and outputs the determined information as scheduling information to coding modulation section 159 using uplink channel quality information of a plurality of mobile stations.

Group determination section 157 determines the group that shares radio resources for retransmission and the order of priority of the users, and outputs the ACK/NACK group information showing the determined group and the determined order of priority to retransmission radio resource determination section 158 and coding modulation section 159. The determined group is limited to updating for a certain time period and is prevented groups from updating frequently, the amount of signaling of the ACK/NACK group information is reduced. Further, by grouping the users having the same the initial transmission RB size, the retransmission RB size is able to be determined easily with reference to the initial transmission RB size.

Based on the ACK/NACK group information and the order of priority outputted from group determination section 157, retransmission radio resource determination section 158 determines the band allocation for retransmitting data that is shared in the group, and outputs the determined retransmission data band allocation information, to resource division section 154 and coding modulation section 159.

Coding modulation section 159 encodes and modulates the ACK/NACK information outputted from data decoding HARQ section 155, the scheduling information outputted from scheduling section 156, the ACK/NACK group information and the order of priority outputted from group determination section 157, the retransmission data band allocation information outputted from retransmission radio resource determination section 158 and the user data. The encoded and modulated signal is outputted to radio transmitting section 160.

Radio transmitting section 160 performs radio transmitting processing including frequency conversion on the signal outputted from coding modulation section 159, and outputs the signal after radio transmitting processing from antenna 151.

Next, communication steps between the above described mobile station 100 and base station 150 will be explained using FIG. 5. In FIG. 5, in step (hereinafter abbreviated as “ST”) 201, group determination section 157 in base station 150 determines the ACK/NACK group and the order of priority of the users in the group, and, in ST 202, reports the determined information to mobile station 100.

In ST 203, retransmission radio resource determination section 158 in base station 150 determines the band allocation for retransmission data shared in the group, and, in ST 204, reports the determined retransmission data band allocation information to mobile station 100.

In ST 205, scheduling section 156 in base station 150 determines uplink scheduling, and, in ST 206, reports the determined uplink scheduling information to mobile station 100.

In ST 207, mobile station 100 transmits the data to base station 150 based on the uplink scheduling information reported from base station 150.

In ST 208, based on the data decoding result transmitted from mobile station 100, data decoding HARQ section 155 in base station 150 generates ACK/NACK information, and, in ST 209, reports the generated ACK/NACK information to mobile station 100. Here, assume that data decoding HARQ section 155 generates a NACK.

In ST 210, ACK/NACK decoding section 106 in mobile station 100 decodes the ACK/NACK Information reported from base station 150. Here, the ACK/NACK information shows a NACK to the mobile station, and therefore, in ST 211, based on the AC K/NACK information, retransmission control section 108 in mobile station 100 divides the radio retransmission resources (i.e. the b and allocation for retransmission data) into equal portions, the number of users to which a NACK is shown in the group, and retransmits data using the radio retransmission resources divided into equal portions, the number of users to which a NACK is shown. The processing in ST 208 to ST 211 is repeated until the mobile station receives an ACK or until the maximum number of retransmission is reached.

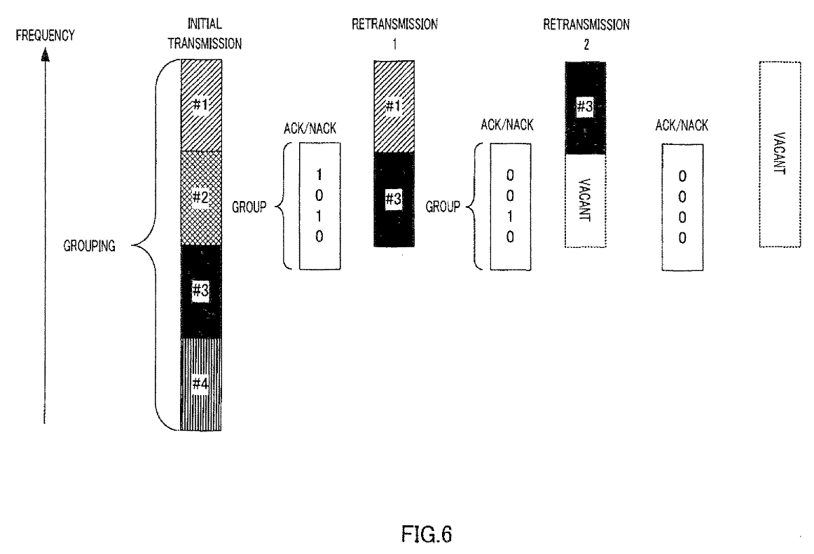

Next, the method of radio retransmission resource allocation upon data retransmissions will be described using FIG. 6. Here, four users, user #1 to user #4, are grouped, and ACKs and NACKs transmitted to user #1 to user #4 can be decoded by the us ers. Further, two consecutive RBs from the highest frequency are defined in advance as the radio retransmission resources (RBs) amongst RBs for the initial transmission. The RB size is calculated from the initial transmission RB size and the average retransmission probability. Furthermore, an ACK is defined as “0” and a NACK is defined as “1.”

If 0s and 1s are reported in order from user #1 to user #4, and, for example, if ACK/NACK information shows “1010,” it is possible to identify that there have been errors in two users, user #1 and user #3. Consequently, the RBs for retransmission are allocated to two users, and user #1 and user #3 retransmit data using the allocated RBs. Here, the base station reports the order of priority of retransmission RB positions on a per user basis to the mobile station in advance, so that, if user #1 to user #4 are assigned in descending order of priority, it is possible to allocate the RB of a higher frequency to user #1 and allocate the RB of a lower frequency to user 43.

When ACK/NACK information shows “0010” as a result of data retransmission by user #1 and user #3, it is determined that there have been errors in user #3, so that the retransmission RB is allocated to user #3. FIG. 6 shows a case where ACK/NACK information shows “0000” as a result of data retransmission by user #3 (retransmission for two times), and by this means d at a transmission for user #1 to user #4 is completed normally.

In this way, according to Embodiment 1, to carry out data communication between a mobile station and base station using synchronous HARQ, a plurality of users are grouped, either high frequencies or low frequencies in the initial transmission resources allocated to a plurality of users in a group are designated in advance as radio retransmission resources, and the radio retransmission resources are shared by a plurality of users in the group, so that it is possible to reduce fragmentation of radio resources without increasing the amount of signaling.

Although a case has been explained with the present embodiment where the retransmission RB size is calculated from the initial transmission RB size and the average retransmission probability, the retransmission RB size may be calculated from the initial transmission RB size, the average retransmission probability and the number of retransmissions on a per retransmission basis.

Further, although a case has been explained with the present embodiment where an RB of a higher frequency is allocated to a user of higher priority and an RB of a lower frequency is allocated to a user of lower of priority amongst the retransmission RBs, an RB of a lower frequency may be allocated to a user of higher priority and an RB of a higher frequency may be allocated to a user of lower priority amongst the retransmission RBs.

Further, although a case has been explained with the present embodiment where users of the same initial transmission RB size are grouped, users of different initial transmission RB sizes may be grouped into the same group.

Further, although a case has been explained with the present embodiment to designate either high frequencies or low frequencies in the initial transmission resources allocated to a plurality of users in a group in advance as radio retransmission resources, whether higher frequencies or lower frequencies are designated as radio retransmission resources may be reported separately.

### Embodiment 2

The configurations of the mobile station and the base station according to Embodiment 2 of the present invention are the same as the configuration according to Embodiment 1 shown in FIGS. 3 and 4, and this embodiment will be explained with reference to FIGS. 3 and 4, and therefore the overlapping description will be omitted.

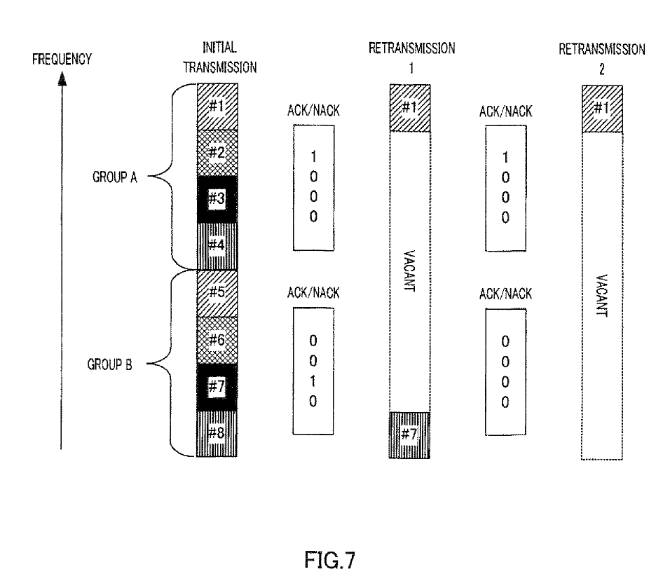

The method of radio retransmission resource allocation upon data retransmissions according to Embodiment 2 of the present invention will be described using FIG. 7. Here, groups A and B are provided in the system band, four users, user #1 to user #4, are grouped (group A), and ACKs and NACKs transmitted to user #1 to user #4 can be decoded by the users in group A. Further, four users, user #5 to user #8, are grouped (group B) and ACKs and NACKs transmitted to user #5 to user #8 can be decoded by the users in group B.

The radio retransmission resources (RBs) are defined at the ends of the system band in advance, that is, the radio retransmission resources of group A use the higher frequency in the system band and the radio retransmission resources of group B use the lower frequency in the system band. Furthermore, an ACK is defined as “0” and a NACK is defined as “1.”

If 0s and 1s are reported in order from user #1 to user #4 in group A, and, for example, if ACK/NACK information of group A shows “1000,” it is possible to identify that there have been errors in user #1. Further, if 0s and 1s are reported in order from user #5 to user #8 in group B, and, for example, if ACK/NACK information of group B shows “0010,” it is possible to identify that there have been errors in user #7.

Therefore, the retransmission RB is allocated to user #1 in group A and the retransmission RB is allocated to user #7 in group B.

When ACK/NACK information in group A shows “1000” and ACK/NACK information in group B shows “0000,” as a result of data retransmission by user #1 and user #7, it is identified that there have been errors in user #1, so that the retransmission RB is allocated to user #1 in group A.

In this way, according to Embodiment 2, by using the ends of the system band for radio retransmission resources, it is possible to reduce fragmentation of radio resources without increasing the amount of signaling.

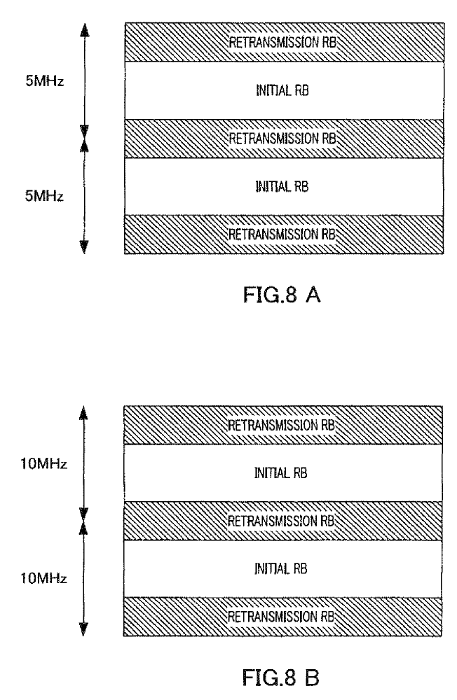

Although a case has been explained with the present embodiment where the system band is about 5 MHz and where radio retransmission resources are provided at the ends of the system band, radio retransmission resources may be provided every 5 MHz as shown in FIG. 5A in the wider system band, for example, 10 MHz, and, radio retransmission resources may be provided every 10 MHz (or every 5 MHz) as shown in FIG. 8B in 20 MHz.

Further, although a case has been explained with the present embodiment to provide radio retransmission resources at the ends of the system band, when, for example, control channels are used at the ends, frequency resources located nearby the control channels may be provided as radio retransmission resources.

### Embodiment 3

The configurations of mobile station and the base station according to Embodiment 3 of the present invention are the same as the configuration according to Embodiment 1 shown in FIGS. 3 and 4, and this embodiment will be explained with reference to FIGS. 3 and 4, and therefore the overlapping description will be omitted.

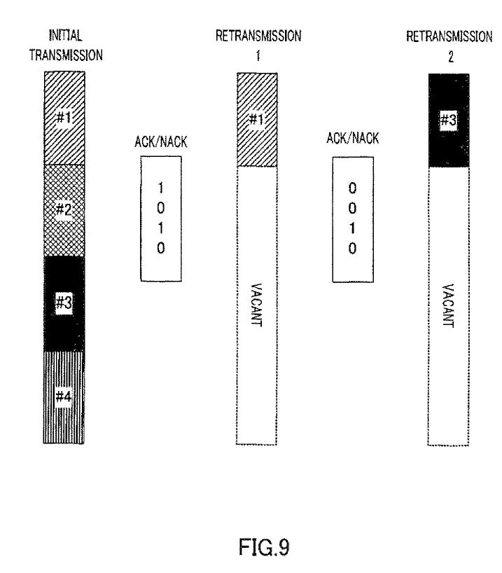

The method of radio retransmission resource allocation upon data retransmissions according to Embodiment 3 of the present invention will be described using FIG. 9. Here, four users, user #1 to user #4, are grouped, and ACKs and NACKs transmitted to user #1 to user #4 can be decoded by the users.

Further, one RB of a higher frequency is defined in advance as the radio retransmission resource (RB) amongst RBs for the initial transmission. The RB size is calculated from the initial transmission RB size and the average retransmission probability. Further, an ACK is defined as “0” and a NACK is defined as “1.” Furthermore, order of time priority is determined for users in advance, for example, user #1 to user #4 are assigned in descending order of priority.

If 0s and 1s are reported in order from user #1 to user #4, and, for example, if ACK/NACK information shows “1010” in group A, it is possible to identify that there have been errors in two users, user #1 and user #3. Here, user #1 has high time priority, the retransmission RB is allocated to user 41, and user #3 retransmission by user #3 is in a wait.

When ACK/NACK information shows “0010” as a result of data retransmission by user 41, it is possible to identify that data error of user #1 is resolved and there are still errors in user #3, so that the retransmission RB is allocated to user #3.

In this way, according to Embodiment 3, when there are few resources and it is not possible to cover the number of users requiring retransmissions with retransmission for one time, it is possible to reduce fragmentation of radio resources without increasing the amount of signaling by determining order of time priority in advance for the users in a group and by carrying out retransmissions according to the order of time priority.

With the present embodiment, by place a user higher of retransmission probability in the order of priority to the top of the priority, it is possible to retransmit data efficiently.

### Embodiment 4

The configurations of the mobile station and the base station according to Embodiment 4 of the present invention are the same the configuration according to Embodiment 1 as shown in FIGS. 3 and 4, and this embodiment will be explained with reference to FIGS. 3 and 4, and therefore the overlapping description will be omitted.

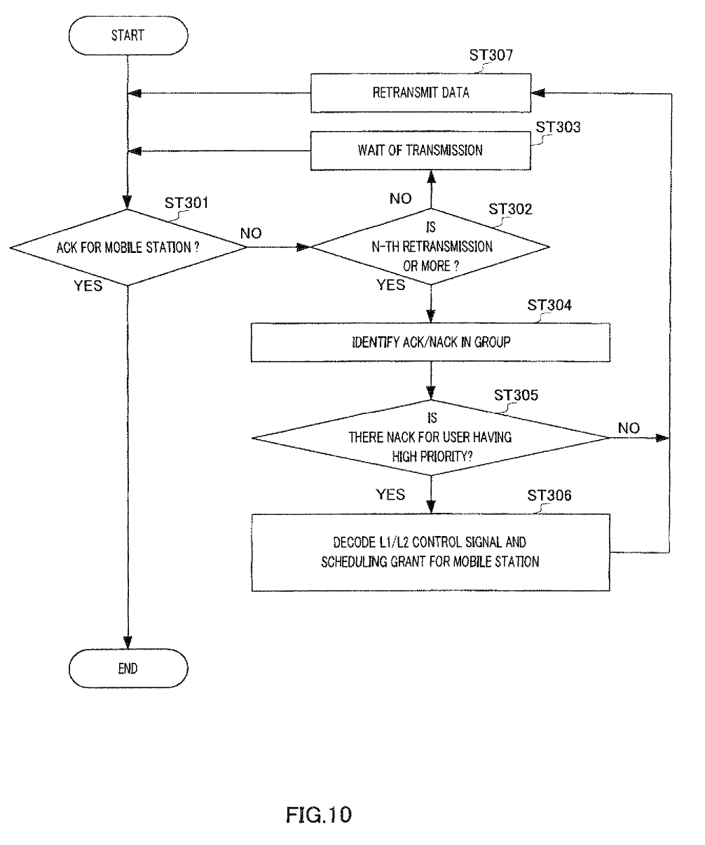

FIG. 10 is a flow chart showing the processing of the mobile station according to Embodiment 4 of the present invention. Referring to this figure, in ST 301, ACK/NACK information transmitted from the base station to the mobile station is identified as an ACK or not, and, if an ACK is identified, the processing ends, and if an ACK is not identified, that is, a NACK, the step moves to ST 302.

In ST 302, whether or not retransmission for this time is a N-th transmission or more, and, if the retransmission is a N-th retransmission or less “No,” the step moves to ST 303, in which the retransmission is in a wait, and returns to ST 301. Further, if the retransmission is a Nth or more “Yes,” the step moves to ST 304. N is called “designated number of retransmissions.”

In ST 304, ACKs/NACKs in a group are identified, and, in ST 305, whether or not there is a NACK for a user of a higher priority than the mobile station is decided. If there is a NACK for a user of a higher priority than the mobile station “Yes”, the step moves to ST 306, and, if there is not a NACK for a user of a higher priority than the mobile station “No>”, the step moves to ST 307.

In ST 306, a L1/L2 control signal is decoded and scheduling grant for the mobile station is decoded, and, in ST 307, data is retransmitted.

Next, the method of radio retransmission resource allocation upon data retransmissions will be described. Here, four users, user #1 to user #4, are grouped, and ACKs and NACKs transmitted to user #1 to user #4 can be decoded by the users.

Further, one RB of a higher frequency is defined in advance as the radio retransmission resource (RB) in advance amongst RBs for the initial transmission. The RB size is calculated from the initial transmission RB size and the average retransmission probability. Further) an ACK is defined as “0” and a NACK is defined as “1.” Furthermore, order of priority is determined for users in advance, for example, user #1 to user #4 are assigned in descending order of priority.

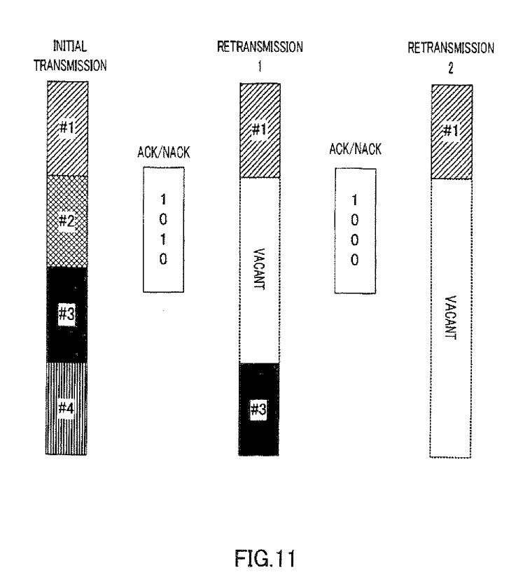

The case of designated number of retransmissions N=1 will be explained using FIG. 11. If 0s and 1s are reported in order from user #1 to user #4, and, for example, if AC K/NACK information for the initial transmission shows “1010,” it is possible to identify that there have been errors in two users, user #1 and user #3. Here, user 41 has high priority and the retransmission RB is allocated to user #1, and an vacant field is allocated freely to user #3.

When ACK/NACK information shows “1000” as a result of data retransmission by user #1 and user #3, it is possible to identify that data error of user #3 is resolved and there are still errors in user #1, so that the retransmission RB is allocated to user #1.

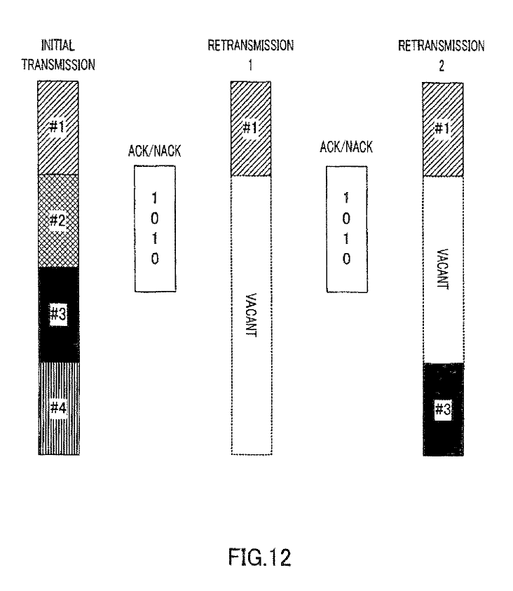

The case of designated number of retransmissions N=2 will be explained using FIG. 12. For example, if ACK/NACK information for the initial transmission shows “1010,” it is possible to identify that there have been errors in two users, user #1 and user #3. Here, user #1 has high priority, the retransmission RB is allocated to user #1, and retransmission by user #3 having low priority is in a wait.

When ACK/NACK information shows “1010” as a result of data retransmission by user #1, it is still possible to identify that there are errors in user #1 and user #3, so that the retransmission RB is kept allocated to user #1 and a free area is allocated freely to user #3.

In this way, according to Embodiment 4, the number of retransmissions is equal to or more th an the designated number of retransmissions, and, when a plurality of users retransmit data at the same time, by allocating vacant resources to users of a lower priority, it is possible to reduce the delay time of user data.

Although a case has been explained above with the present embodiment where retransmission RBs are allocated to users of a higher priority and vacant resources are allocated freely to users of a lower priority, vacant resources may be allocated freely to users of a higher priority and retransmission RBs, may be allocated to users of a lower of priority.

### Embodiment 5

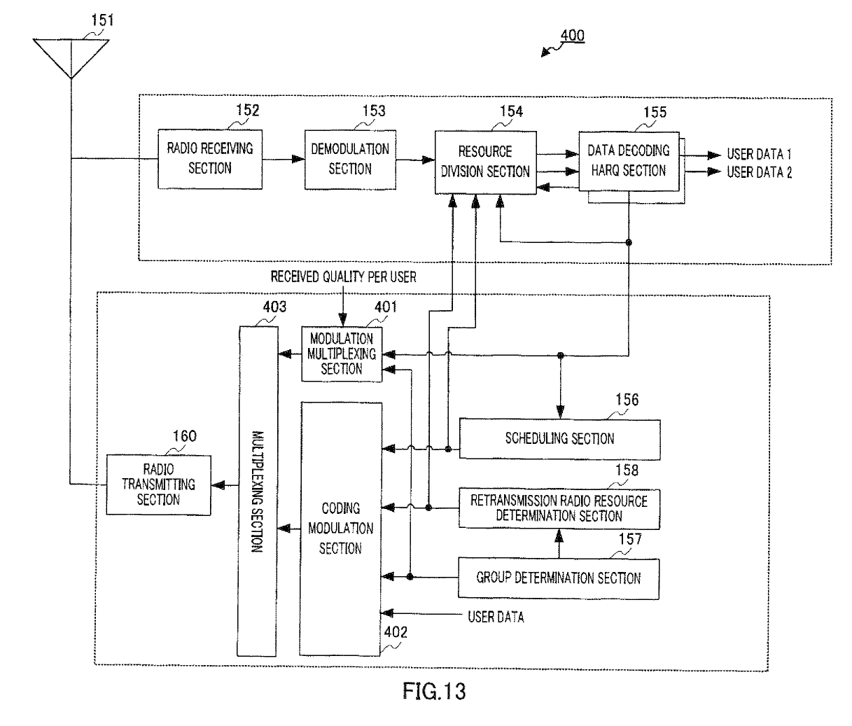

The configuration of base station 400 according to Embodiment 5 of the present invention will be explained using FIG. 13. FIG. 13 is different from FIG. 4 in adding modulation multiplexing section 401 and multiplexing section 403 and in changing coding modulation section 159 to coding modulation section 402.

Based on ACK/NACK information outputted from data decoding HARQ section 155, ACK/NACK group information and order of priority outputted from group determination section 157 and the received quality per user, modulation multiplexing section 401 determines the amount of transmission power offset on a per user basis. To be more specific, the amount of transmission power offset to an ACK/NACK signal increases for a user of higher priority to improve the communication quality of an ACK/NACK signal. Here, if the number of grouped users is M, the amount of transmission power offset for a user of priority #N is determined to meet the received quality of all users of priority #N to #M (i.e. SINR, signal to interference and noise ratio).

For example, if M=4, the received quality of user #1 to user #4 is SINK #1 to SINR #4, and the order of priority of user #1 to user #4 is priority order #1 to #4, the amounts of transmission power offset are as follows. The reference SINR is, for example, SINR #4 and Min(SINR #1 to SINR #4) represents the minimum value amongst SINR #1 to SINK #4.

The amount of transmission power offset in priority order #1=reference SINR−Min(SINR #1 to SINR #4)

The amount of transmission power offset in priority order #2=reference SINR−Min(SINR #2 to SINK #4)
The amount of transmission power offset in priority order #3=reference SINR−Min(SINR #3 to SINR #4)
The amount of transmission power offset in priority order #4=0

In this way, by determining the amount of transmission power offset according to priority, the error robustness of ACK/NACK signals for users of higher priority can improve. By this means, it is possible to prevent collisions upon retransmissions from terminals.

Modulation multiplexing section 401 performs CDM modulation on an ACK/NACK signal for each user, adds the determined amount of transmission power offset to the CDM modulated signals and CDM multiplexes. The CDM-multiplex signal is outputted to multiplexing section 403.

Coding modulation section 402 encodes and modulates the scheduling information outputted from scheduling section 156, the ACK/NACK group information and the order of priority outputted from group determination section 157, the retransmission data band allocation information outputted from retransmission radio resource determination section 158 and the user data. The encoded and modulated signal is outputted to multiplexing section 403.

Multiplexing section 403 OFDM-multiplexes the CDM multiplexed signal outputted from modulation multiplexing section 401 and the signal outputted from coding modulation section 402, and outputs OFDM multiplexed signal to radio transmitting section 160. Modulation multiplexing section 401, multiplexing section 403, and radio transmitting section 160 function as a transmission means.

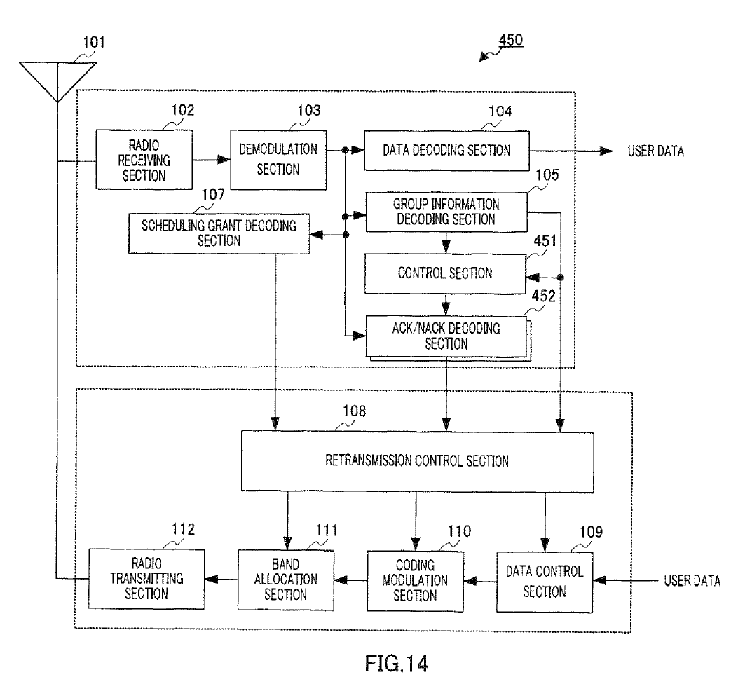

The configuration of base station 450 according to Embodiment 5 of the present invention will be explained using FIG. 14. FIG. 14 is different from FIG. 3 in adding control section 451 and in changing ACK/NACK decoding section 106 to ACK/NACK decoding section 452.

Using ACK/NACK group information and order of priority of users in a group outputted from group information decoding section 105, control section 451 selects the user that decodes the ACK/NACK, and outputs user selection information designating the selected user to ACK/NACK decoding section 452.

Based on the user selection in formation outputted from control section 451, ACK/NACK decoding section 452 decodes the ACK/NACK signal outputted from demodulation section 103, and outputs decoded ACK/NACK information to retransmission control section 108.

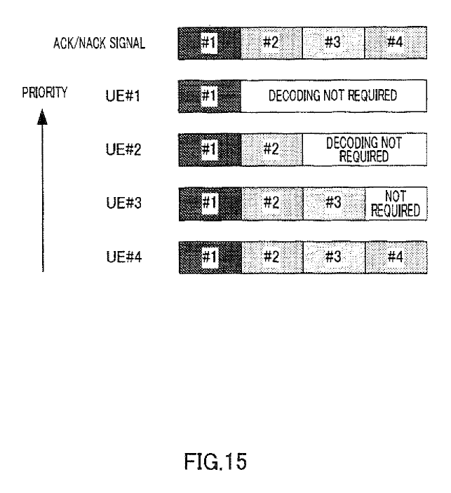

Here, the user selection method in control section 451 will be explained using FIG. 15. Here, four users, user #1 to user #4, are grouped, and high priority is given from user #1 to user #4. As shown in FIG. 15, if the mobile station is user #1 of the highest priority in this group, control section 451 selects user #1, and outputs user selection information showing user #1 to ACK/NACK decoding section 452. By this means, user #1 decodes only the ACK/NACK information for the mobile station in ACK/NACK decoding section 452. That is, user #1, having the highest priority in the group, does not have to take it into consideration of the order of priority Of other users, and therefore does not need to decode ACK/NACK information for other users.

Further, if the mobile station is user #2 of the second highest priority in this group, control section 451 selects user #1 and user #2, and outputs user selection information showing user #1 and user #2 to ACK/NACK decoding section 452. By this means, user #2 decodes the ACK/NACK information for user #1 and user #2 in ACK/NACK decoding section 452.

Further, if the mobile station is user #3 of the third highest priority in this group, control section 451 selects user #1 to user 3, and outputs the user select ion information showing user #1 to user #3 to ACK/NACK decoding section 452. By this means, user #3 decodes the ACK/NACK information for user #1 to user #3 in ACK/NACK decoding section 452.

Further, if the mobile station is user #4 of the lowest priority in this group, control section 451 selects user #1 to user #4, and outputs user selection information showing user #1 to user #4 to ACK/NACK decoding section 452. By this means, user #4 decodes the ACK/NACK information for user #1 to user #4 in ACK/NACK decoding section 452.

In this way, by decoding an ACK/NACK signal for a certain mobile station and ACK/NACK signals for users of higher priority than the certain mobile station and by not decoding ACK/NACK signals for users of lower priority than the certain mobile station, it is possible to reduce load to decode ACK/NACK signals when users have higher priority. It is possible to prevent collisions upon retransmissions without decoding ACK/NACK signals for users of lower order of priority than the mobile station.

In this way, according to Embodiment 5, in the base station, by adding the amount of transmission power offset according to priority of users, to transmission power for an ACK/NACK signal of each user, it is possible to improve error robustness of an ACK/NACK signal for a user of higher priority and prevent collisions upon retransmissions.

Although a case has been explained above where ACK/NACK signals are subject to CDM multiplexing, the present invention is not limited to this, and ACK/NACK signals may be subject to FDM multiplexing.

### Embodiment 6

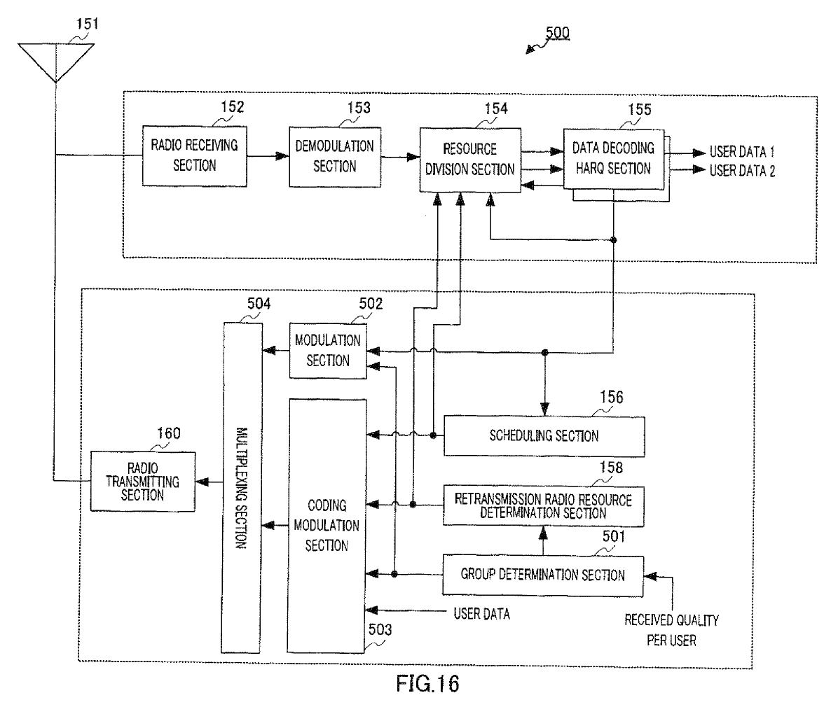

The configuration of base station 500 according to Embodiment 6 of the present invention will be explained using FIG. 16. In addition, FIG. 16 is different from FIG. 4 in adding modulation section 502 and multiplexing section 504 and in changing group determination section 157 to group determination section 501 and coding modulation section 159 to coding modulation section 503.

Based on received quality on a per user basis, group determination section 501 determines the group that shares radio retransmission resources and the order of priority of users, and outputs ACK/NACK group information showing the determined group and order of priority to retransmission radio resource determination section 158, modulation section 502 and coding modulation section 503.

Based on ACK/NACK information outputted from data decoding HARQ section 155, ACK/NACK group information and order of priority outputted from group determination section 501, modulation section 502 determines the bit allocation for ACK/NACK signals on a per user basis and performs M-ary modulation. Here, modulation scheme is 16 QA M, four us ers, user #1 to user #4, are grouped, and user #1 to user #4 are assigned in descending order of priority.

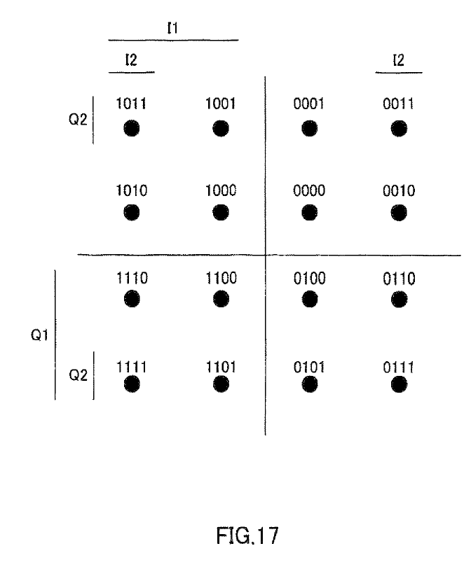

Generally, when bits are allocated to a given signal point, error robustness decreases in ascending order from the first bit to a fourth bit. That is, the first bit has the strongest error robustness and a fourth bit has the weakest error robustness. Then, modulation section 502 allocates ACK/NACK signals for user #1 to user #4 to the first bit to the fourth bit in descending order of priority. FIG. 17 shows the signal points of 16 QAM. Signal point detection is carried out in order of I1, I2, Q1 and Q2. M-ary modulated ACK/NACK signal is outputted to multiplexing section 504.

Coding modulation section 503 encodes and modulates the scheduling information outputted from scheduling section 156, the ACK/NACK group information and the order of priority outputted from group determination section 501, the retransmission data band allocation in formation outputted from retransmission radio resource determination section 158 and the user data. The encoded and modulated signal is outputted to multiplexing section 504.

Multiplexing section 504 OFDM-multiplexes the ACK/NACK signal outputted from modulation section 502 and the signal outputted from coding modulation section 503, and outputs the OFDM multiplexed signal to radio transmitting section 160.

Here, the group determination method in group determination section 501 will be explained. Group determination section 501 selects users to be grouped such that a difference in the required SINR between of I1 (Q1) and I2 (Q2) shown in FIG. 17 equals a difference in the SINR between users, and determines the group and order of priority of the users. To be more specific, for example, users having a 3 dB difference in the required SINR between I1 and I2 are grouped into the same group, group determination section 501 sets higher priority for a grouped user of lower SINR and sets lower priority for a user of higher SINR.

In this way, according to Embodiment 6, upon performing M-ary modulation on ACK/NACK signals for each user in the base station, by allocating bits according to the order of priority of users and mapping the ACK/NACK signal in a group to one symbol, it is possible to improve error robustness of an ACK/NACK signal for users of high priority and prevent collisions upon retransmissions.

Although a case has been explained above with the present embodiment to group four users and perform 16 QAM modulation, if three users are to be grouped, an ACK/NACK signal (bit) for user #3 may be allocated to the third bit and the fourth bit, and the receiving side may combine these bits.

Further, although a case has been explained above with the present invention to group four users and perform 16 QAM modulation, 64 QAM modulation may be performed if six users are grouped and 256 QAM modulation may be performed if eight users are grouped.

### Embodiment 7

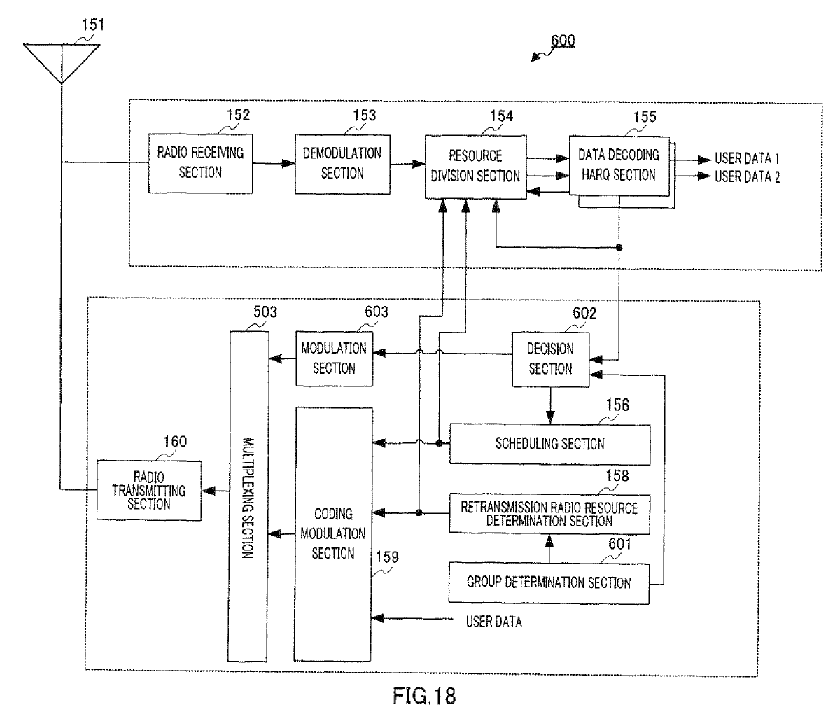

The configuration of base station 600 according to Embodiment 7 of the present invention will be explained using FIG. 18. FIG. 18 is different from FIG. 16 in adding decision section 602 and changing group determination section 501 to group determination section 601 and modulation section 502 to modulation section 603.

Group determination section 601 determines the group that shares radio retransmission resources and the order of priority of the users, and outputs the ACK/NACK group information showing the determined group and order of priority to retransmission radio resource determination section 158 and ACK/NACK group information to decision section 602.

Based on the ACK/NACK group information outputted from group determination section 601 and the ACK/NACK information outputted from data decoding HARQ section 155, decision section 602 decides the number of NACK users in the group. If the number of NACK users is one, decision section 602 decides to use the NACK channel to report a NACK to the applicable user, and, if the number of NACK users is two or more, decision section 602 decides to use the NACK channel to report a NACK to one user of the highest priority amongst the applicable users and use the L1/L2 control channel (i.e. scheduling channel) to report a NACK to other users. These decision results are outputted to modulation section 603 and scheduling section 156.

Based on the decision result outputted from decision section 602, modulation section 603 forms the NACK channel and L1/L2 control channel, and outputs the formed NACK channel and L1/L2 control channel to multiplexing section 503. In the case where the decision result designates an ACK, nothing is reported.

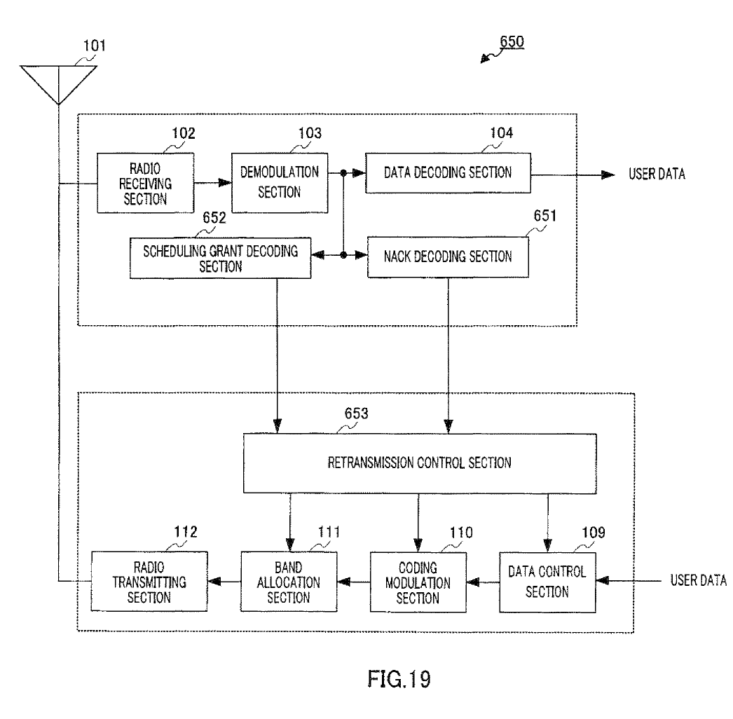

The configuration of mobile station 650 according to Embodiment 7 of the present invention will be explained using FIG. 19. FIG. 19 is different from FIG. 3 in removing group information decoding section 105, and in changing ACK/NACK decoding section 106 to NACK decoding section 651, scheduling grant decoding section 107 to scheduling grant decoding section 652 and retransmission control section 108 to retransmission control section 653.

When the NACK channel is outputted from demodulation section 103, NACK decoding section 651 decodes the NACK channel, and notifies retransmission control section 653 that non-adaptive HARQ is performed.

Scheduling grant decoding section 652 decodes the L1/1L2 control channel outputted from demodulation section 103. When the decoded L1/L2 control channel is addressed to the mobile station, scheduling grant decoding section 652 determines a NACK, and notifies retransmission control section 653 that adaptive-HARQ is performed.

Based on the notification from NACK decoding section 651 that non-adaptive HARQ is performed, or the notification from scheduling grant decoding section 652 that adaptive HARQ is performed, retransmission control section 653 determines the MCS, RV and band allocation information (RB size, RB position). Further, if a notification that non-adaptive HARQ is performed does not arrive from NACK decoding section 651 and a notification that adaptive HARQ is performed does not arrive from scheduling grant decoding section 652, retransmission control section 653 identifies to have received an ACK.

In this way, according to Embodiment 7, by notifying a NACK to the NACK user of the highest priority using a NACK channel and notifying NACKs to other NACK users using a L1/L2 control channel, and by determining in advance that users which are not notified these NACKs identify to have received an ACK, that is, notifying an ACK implicitly, it is possible to improve communication quality of an ACK and prevent collisions upon retransmissions.

Further, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSIs, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible. Further, in the embodiments, the base station may be referred to as a “Node B, and the mobile station may be referred to as a “UE.”

The disclosures of Japanese Patent Application No. 2007-045979, filed on Feb. 26, 2007, and Japanese Patent Application No. 2007-161933, filed on Jun. 19, 2007, including the specifications, drawings and abstracts, are incorporated herein by reference in their entirety.

### INDUSTRIAL APPLICABILITY

The radio communication terminal apparatus, radio communication base station apparatus and radio resource allocation method according to the present invention can reduce fragmentation of radio resources while suppressing an increase in the amount of signaling upon data retransmissions, and are applicable to for example, mobile communication systems.

1-20. (canceled)

21. A communication terminal apparatus comprising:
a receiving section that receives acknowledgment and negative acknowledgment signals for a plurality of communication terminal apparatuses placed in a group;
a decoding section that decodes the received acknowledgment and negative acknowledgment signals;
a retransmission control section that allocates radio resources for retransmission for shared use in the group, based on the decoded acknowledgment and negative acknowledgment signals; and
a transmission section that transmits retransmission data using the allocated radio resources for retransmission.

22. The communication terminal apparatus according to claim 21, wherein the radio resources for retransmission comprise consecutive radio resources on a higher frequency end or lower frequency end.

23. The communication terminal apparatus according to claim 21, wherein the acknowledgment and negative acknowledgment signals are decodable by all radio communication terminal apparatuses in the group.

24. The communication terminal apparatus according to claim 21, wherein the receiving section receives group information showing the communication terminal apparatus and other communication terminal apparatuses, the group information in which updating the group is limited for a certain time period and that is transmitted to other communication terminal apparatuses in the group at a same time.

25. The communication terminal apparatus according to claim 24, wherein, when the communication terminal apparatus and other transmission apparatuses are grouped in an initial data transmission, the receiving section receives the group information showing the same communication terminal apparatuses as the communication terminal apparatuses upon the initial data transmission.

26. The communication terminal apparatus according to claim 21, wherein the receiving section receives the group information showing the communication terminal apparatuses having the same size of the radio resources for initial transmission.

27. The communication terminal apparatus according to claim 21, wherein the retransmission control section allocates the radio resources for retransmission in a size determined based on a size of the radio resources for initial transmission and average retransmission probability.

28. The communication terminal apparatus according to claim 21, wherein the retransmission control section allocates the radio resources for retransmission in a size determined based on a size of the radio resources for initial transmission, average retransmission probability and the number of retransmissions on a per retransmission basis.

29. The communication terminal apparatus according to claim 21, wherein the retransmission control section assigns a radio resource located at an edge of a system band as the radio resources for retransmission.

30. The communication terminal apparatus according to claim 21, wherein, based on order of priority assigned to the communication terminal apparatuses in the group, the retransmission control section allocates the radio resources for retransmission of a higher frequency to higher priority and the radio resources for retransmission of a lower frequency to lower priority.

31. The communication terminal apparatus according to claim 21, wherein, based on order of priority assigned to the communication terminal apparatuses in the group, the retransmission control section allocates the radio resources for retransmission to a communication terminal apparatus in order from a communication terminal apparatus of a highest priority.

32. The communication terminal apparatus according to claim 31, wherein, when the communication terminal apparatus has lower priority than other communication terminal apparatuses in the group and requires retransmission at the same time with the other communication apparatuses, retransmission control section places transmission of retransmission data in a wait.

33. The communication terminal apparatus according to claim 31, wherein, when the communication terminal apparatus has lower priority than other communication terminal apparatuses in the group and requires a retransmission at the same time with the other communication apparatuses, the retransmission control section adaptively allocates radio resources other than the radio resources for retransmission.

34. The communication terminal apparatus according to claim 32, wherein, when a number of retransmission is equal to or more than a predetermined number, the retransmission control section adaptively allocates radio resources other than the radio resources for retransmission.

35. The communication terminal apparatus according to claim 31, wherein the order of priority is assigned in order from the communication terminal apparatus of the highest probability of retransmission.

36. The communication terminal apparatus according to claim 21, wherein, based on order of priority assigned to the communication terminal apparatuses in the group, the decoding section decodes an acknowledgment and negative acknowledgment signal for the communication terminal apparatus and acknowledgment and negative acknowledgment signals for communication terminal apparatuses of a higher priority than the communication terminal apparatus.

37. A base station apparatus comprising:
a group determination section that determines a group of a plurality of communication terminal apparatuses sharing radio resources for retransmission and determines order of priority in the plurality of communication terminal apparatuses; and
a transmitting section that transmits acknowledgment and negative acknowledgment signals of quality according to the priority for the communication terminal apparatuses placed in the group.

38. The base station apparatus according to claim 37, wherein the acknowledgment and negative acknowledgment signals are decodable by all radio communication terminal apparatuses in the group.

39. The base station apparatus according to claim 37, wherein the transmission section transmits the acknowledgment and negative acknowledgment signals with greater transmission power to a communication terminal apparatus of higher priority.

40. The base station apparatus according to claim 39, wherein, using the order of priority and received quality of the communication terminal apparatuses in the group, the transmission section determines amounts of transmission power offset of the acknowledgment and negative acknowledgment signals on a per communication terminal apparatus basis and adds the determined amounts of transmission power offset to the acknowledgment and negative acknowledgment signals.

41. The base station apparatus according to claim 37, wherein the transmission section comprises a modulation section that allocates bits of improved error robustness to an acknowledgment and negative acknowledgment signal for the communication terminal apparatus of a higher priority and maps acknowledgment and negative acknowledgment signals for the communication terminal apparatuses in the group to one symbol.

42. The base station apparatus according to claim 41 wherein the group determination section determines a plurality of communication terminal apparatuses to be grouped based on communication quality every bit of the acknowledgment and negative acknowledgment signals mapped by the modulation section.

43. A radio resource allocation method comprising:
receiving acknowledgment and negative acknowledgment signals for a plurality of communication terminal apparatuses placed in a group;
decoding the received acknowledgment and negative acknowledgment signals; and
allocating radio resources for retransmission for shared use in the group, based on the decoded acknowledgment and negative acknowledgment signals.
